(19) United States
(12) Patent Application Publication
(10) Pub. No.: US 2020/0184553 A1
(43) Pub. Date: Jun. 11, 2020

(54) SMART CONTRACT BASED CREDIT NETWORK

(71) Applicant: RIPIO International SEZC, Grand Cayman (KY)

(72) Inventors: Sebastian Serrano, Ciudad Autonoma de BuenosAires (AR); Luciana Marcela Gruszeczka, Madrid (ES); David Garcia, Clermont, FL (US)

(73) Assignee: RIPIO International SEZC, Grand Cayman (KY)

(21) Appl. No.: 16/628,522

(22) PCT Filed: Jul. 5, 2018
(86) PCT No.: PCT/US2018/040953

§ 371 Date: Jan. 3, 2020

Related U.S. Application Data
(60) Provisional application No. 62/528,844, filed on Jul. 5, 2017.

(51) Int. Cl. G06Q 40/02; G06Q 20/40; G06Q 20/38

(52) U.S. Cl. CPC G06Q 40/025; G06Q 20/3829; G06Q 20/405

(57) ABSTRACT

A system includes credit network computing device(s) coupled to wallet provider computing device(s) and credit exchange computing device(s). Wallet provider computing device(s) receives credit request for loan having credit terms from borrower; generates smart contract including information regarding borrower and credit terms; and communicates smart contract to credit network computing device(s). Credit network computing device(s) receives indication that cosigner agrees to cosign for credit request on behalf of borrower; and communicates smart contract representing credit requests to credit exchange computing device(s). Credit exchange computing device(s) places smart contract representing credit request on order book. Credit exchange computing device(s) receives trading order for smart contract representing credit request from lender. Credit exchange computing device(s) determines whether trading order for lender matches credit terms of smart contract representing credit request; and executes loan between borrower, cosigner, and lender when trading order for lender matches credit terms of smart contract representing credit request.

### CROSS-REFERENCE TO RELATED APPLICATIONS

This application claims the benefit of U.S. Provisional Patent Application Ser. No. 62/528,844 filed on Jul. 5, 2017, entitled “SMART CONTRACT BASED CREDIT NETWORK”, which is hereby incorporated herein by reference.

### BACKGROUND

The credit system enable funding to flow from areas with surpluses to areas with the need for financing.

### SUMMARY

A system includes: at least one wallet provider computing device; at least one credit network computing device communicatively coupled to the at least one wallet provider computing device; and at least one credit exchange computing device communicatively coupled to the at least one credit network computing device. The at least one wallet provider computing device is configured to receive a credit request for a loan having credit terms from a borrower from a borrower computing device communicatively coupled to the at least one wallet provider computing device. The at least one wallet provider computing device is configured to generate a smart contract including information regarding the borrower and the credit terms. The at least one wallet provider computing device is configured to communicate the smart contract to the at least one credit network computing device. The at least one credit network computing device is configured to receive an indication that a cosigner agrees to cosign for the credit request on behalf of the borrower. The at least one credit network computing device is configured to communicate the smart contract representing the credit requests to the at least one credit exchange computing device. The at least one credit exchange computing device is configured to place the smart contract representing the credit request on an order book of the at least one credit exchange computing device. The at least one credit exchange computing device is configured to receive a trading order for a lender for the smart contract representing the credit request from a lender computing device. The at least one credit exchange computing device is configured to determine whether the trading order for the lender matches the credit terms of the smart contract representing the credit request. The at least one credit exchange computing device is configured to execute the loan between the borrower, the cosigner, and the lender when the trading order for the lender matches the credit terms of the smart contract representing the credit request.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a block diagram of smart contract based credit system/network.

FIG. 2 is a block diagram of an example computing device for use within the smart contract based credit system/network.

FIG. 3 is a flow diagram of an example method for implementing a smart contract based credit system/network.

FIG. 4 illustrates an example of a computer system with which some embodiments of the present disclosure may be utilized.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

A distributed ledger is an electronic ledger that is distributed across multiple interconnected network nodes, where more than one of the network nodes stores a copy of the ledger. In some embodiments, distributed ledgers implement blockchains to validate the data stored within the distributed ledger.

A blockchain is a verifiable permanent ledger constructed one block at a time with a proof-of-work seal (such as a hash) affixed to each block that validates that block. In any blockchain, the hash of the previous block is included in the current block, and therefore by recursion the current hash also validates all previous blocks back to the original genesis block. Inserting a hash into a blockchain permanently records that hash and acts as a notary verifying proof-of-existence of the hashed data at the moment in time that block is added to the chain. Any future blocks with additional proof-of-work add a layer of protection from a chain re-org and therefore additional certainty that no changes can be made to blocks earlier in the chain.

The importance of the credit system, as one of society's most accomplished collaborative efforts, is unquestionable. Most great ideas would have never seen the light without sharing funds from different people. Credit plays a fundamental role in the economy because it allows money to flow from sectors with surpluses to sectors with the need for financing. This allows to achieve several projects that otherwise could not be carried out.

For hundreds of years the banks have been in charge of intermediation between investors and borrowers, allowing money to flow from investors to borrowers by taking money from investors and lending it to borrowers. While the banking systems role has been important, it has also very inefficient. That explains the high proportion of Gross Domestic Product (GDP) of the banking system in countries. The banking system is not only expensive but also limited. Its operations based on certain geographical locations, its highly bureaucratic processes, and its restrictive credit policies leave out a huge portion of the world's population that today does not have access to banking services. In this line, while the longstanding contribution of traditional banks in worldwide economy is acknowledged, alternative and improved systems can improve over the traditional banking systems' credit selectiveness, renowned bureaucracy, and high-brokerage costs.

New credit and lending alternatives have emerged based on the Internet and peer-to-peer (P2P) technologies that improve most traditional banking services by covering a larger segment of the population and offering new project viabilities. Attempts to implement P2P lending fail due to the high level of default rates because the risk of default was placed completely on the investors such that the interest of the projects and their investor users were misaligned. This was based on a credit risk valuation with the assumption of the existence of a diversified lender, which is often not true. Portfolios of homogeneous loans may be evaluated, without the context that the investors in peer-to-peer (P2P) lending are investing on a much smaller (micro-lending) scale and not in a large portfolio. Even when the expectations for a group of investors are met, some may be very damaged by a default resulting in a non-payment loss. When a non-payment loss occurs, investors who suffer an asset default have been on their own. Most of them have neither the experience nor the tools to perform debt collection strategies. And this problem become even greater for investors who are located far from the borrowers as the lending service becomes more global.

Blockchain technology (and distributed ledgers generally) can be used to channel a loan directly between peers using peer-to-peer (P2P) lending. Blockchain technology enable acceleration of the interaction between lenders and borrowers, reducing the cost of intermediation and allowing access to a greater number of individuals based on the broad reach of the Internet.

Examples of a global peer-to-peer credit network based on cosigned smart contracts and blockchain technology are described herein which use benefits of blockchain technology to enable peer-to-peer (P2P) lending to efficiently solve the mentioned problems by including a third party agent (referred to herein as a “cosigner” or “cosigner”) in addition to the lender and borrower. Because the cosigner shares the risk with the lender, the cosigner also shares an interest in accurately evaluating and managing the loans. In examples, investors transfer part of the risk to the cosigner in exchange for the payment of a small fee. In examples, the cosigner can use these fees collected from different lenders to take charge of the default payments that occur, while continuing to pursue debt collection from the borrower locally in the borrower's country to recover as much debt as possible. In examples, the inclusion of a cosigner substantially reduces the network loss and, as a result, improves credit conditions for both lenders and borrowers, thereby democratizing access to credit and lending.

In examples, the system and methodology is implemented using a protocol based on smart contracts and blockchain technology, which enable credit and lending transparency and reliability. In examples, the protocol connects lenders and borrowers located anywhere in the world using any currency. By reducing the traditional banking brokerage costs and management fees, embodiments of the system and methodology allow better conditions for both sides, thus improving every credit alternative available today. The inclusion of a the third party cosigner minimizes the lender's credit risk and, in case of a default, provides the tools to manage the debt in the borrower's country of residence.

In examples, the system is built using the Ethereum ERC20 protocol with cosigned smart contracts, connecting borrowers and lenders plus the local third party agent (the cosigner) that has country specific legal know-how and sufficient volume to predict the return on investment in each country and to manage the debt and collect the funds in case of default. This allows for a decentralized, trustworthy, predictable, and much more efficient peer-to-peer (P2P) global credit network that makes it possible for many ideas and projects all over the world become to fruition.

With reference to the traditional banking system, the financial system has been one of the main actors of global economy for hundreds of years. Credit, one of its essential functions, consists in managing the savings of a population by channeling these savings from agents with surplus funds (lenders) to others with productive projects but insufficient funds to accomplish them (borrowers). In a hypothetical context in which banks didn't exist as an intermediary agent, both borrowers and lenders should: (1) become aware of each other's existence; (2) agree on how to value the risk involved in the operation; (3) agree on time-limits and amounts; and (4) manage the logistics necessary to actually transfer the money during the credit's lifetime.

Today, bank intermediation reduces these transaction and information costs but with certain limitations: (1) banks focus their operations in determined geographic locations, which makes it difficult for people in different areas to connect; (2) a large amount of the world's population is unbanked, the rest is plainly excluded from the financial system; (3) banks give loans and credit according to their risk capacities, for which some projects are too expensive to be creditworthy and some are simply un-creditable; and d) the standard credit granting process has its inherent bureaucracy which adds costs and excludes even larger segments of the population.

With reference to the internet and the rise of peer-to-peer (P2P) loans, during the last 15 years, the Internet has produced a radical shift in terms of information and communications, setting off an accelerated democratization process on both, at least for people who had access to it. The new social technologies also helped to expand the boundaries of the traditional banking system and new credit alternatives, such as peer-to-peer (P2P) loans, came into existence. These helped the system to move forward on some key points: (1) the whole credit-granting process revved up; (2) the segment of the population covered by the system increased; (3) the localization issue was, up to some point, no longer problem; (4) the intermediation costs were reduced and the P2P rates outweighed most traditional bank rates; (5) the shift brought better conditions for both lenders and borrowers in terms of project creditworthiness.

The Internet-driven shift was big but there were some structural problems to solve: (1) the credit risk was still assumed by the lender, and not by the P2P platform itself; (2) the credit risk evaluation process was also still asymmetric; (3) the lender had only a few management tools to undertake their assets; (4) if the company behind the P2P platform defaults or bankrupted, the lender had zero guarantee of insurance. In this context, the lender is confronted with a binary scenario: its counterpart (borrower) meets its obligations or not. In other words, the risk is too big and not diversifiable.

In examples, the system is a peer-to-peer (P2P) credit network based on cosigned smart contracts using blockchain (or other distributed ledger) technology, leading towards credit democratization by offering a compelling alternative to traditional banking systems. In examples, the system involves several agents to offer the lender better tools to manage their capital, reduce the intermediation costs and, as a result, make more projects viable. In examples, the smart contract connects with the borrower's identity and analyzes the credit risk impartially. In examples, this contract is shared with the cosigner, which is the agent that diversifies the credit risk with a number of investors—hence reducing (and in some cases neutralizing) that risk. In addition, in case of a default, the smart contract allows the cosigner to manage the unpaid debts in a traditional way. The system connects borrowers, lenders and cosigners all over the world, allowing each one of them to manage the credit in their local currencies. In examples, the only requirement is Internet access.

The system/network consists of the following agents and elements: (1) borrower(s), (2) lender(s), (3) cosigner(s), (4) wallet provider(s), (5) smart contract(s), (6) scoring agent(s), (7) price feed(s), identity provider(s), and the credit exchange(s). In examples, the borrower(s) make a credit request from their wallet providers. In examples, the lender(s) make the investment by lending their funds in a credit exchange (to buy credit tokens). In examples, the cosigner(s) act as warrant for the lenders, distributing the credit risk by “sealing” the smart contract generated by the wallet. It is the intermediary agent between the borrower's local legislation and the traditional banking system. In examples, the wallet provider(s) generate a smart contract to receive funds from the lenders and distribute these funds to its users (the borrowers). In examples, the smart contract is generated by the wallet and “sealed” by the cosigner and defines the credit terms and borrowers obligations plus the events of default. In examples, the scoring agent(s) provide a credit scoring for each borrower (and add it to the smart contract). In examples, the price feed(s) set the price feed of the credit token according to the wallet provider's currency (and adds it to the smart contract). In examples, the identity provider(s) verify the borrower(s)′ identity (and adds that information to the smart contract). In examples, the credit exchange(s) allow for credit token trading.

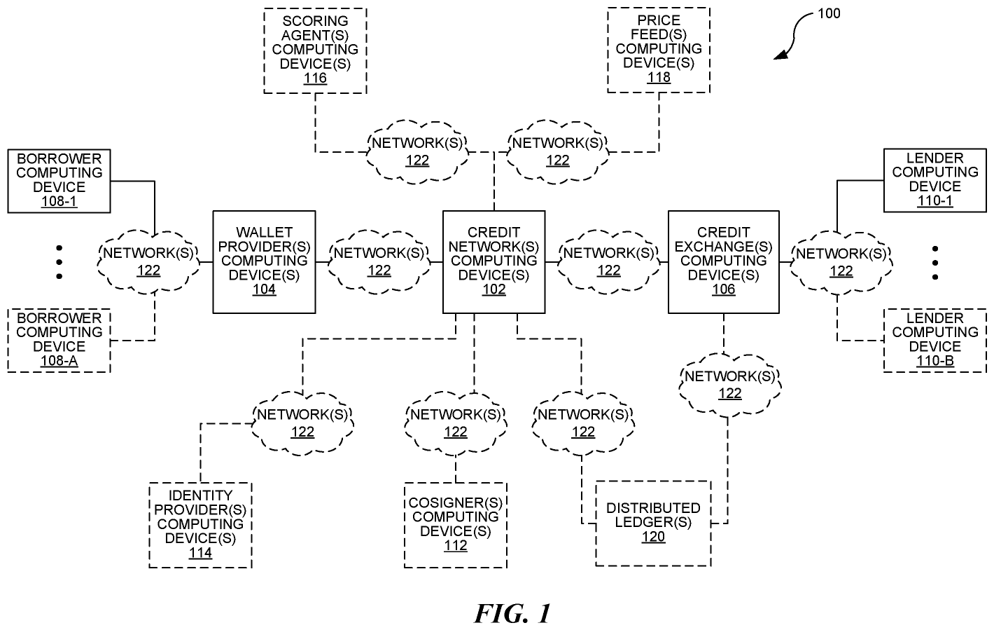

FIG. 1 is a block diagram of a smart contract based credit system (or network) 100. The system 100 includes credit network(s) computing device(s) 102, wallet provider(s) computing device(s) 104, and credit exchange(s) computing device(s) 106. The system 100 includes (or is communicatively coupled to) at least one borrower computing device 108 (such as borrower computing device 108-1 and any quantity of optional borrower computing devices 108 through optional borrower computing device 108-A), at least one lender computing device 110 (such as lender computing device 110-1 and any quantity of optional lender computing devices 110 through optional lender computing device 110-B), optional cosigner(s) computing device(s) 112, optional identity provider(s) computing device(s) 114, optional scoring agent(s) computing device(s) 116, optional price feed(s) computing device(s) 118, and distributed ledger(s) 120 (which may not be necessary in all implementations), all of which can be interconnected with the credit network(s) computing device(s) 102, wallet provider(s), and/or credit exchange(s) computing device(s) 106 through optional network(s) 122.

In examples, the credit network(s) computing device(s) 102, the wallet provider(s) computing device(s) 104, and the credit exchange(s) computing device(s) 106 are network nodes communicatively coupled to one another in a network. In examples, the optional network(s) 122 include wired network(s) and/or wireless network(s). In examples, the optional network (s) 122 include any combination of wired and wireless networks. In examples, the credit network(s) 122 include at least one of at least one local area network (LAN), at least one wide area network (WAN), or the Internet. In examples, the network (s) include any combination of local area networks, wide area networks, and the Internet. In examples, any quantity of intermediary devices are positioned in the optional network(s) 122 in the communication path between various components of (or connected to) the system 100, where the intermediary device perform forwarding, relay, and/or routing of messages between the various components.

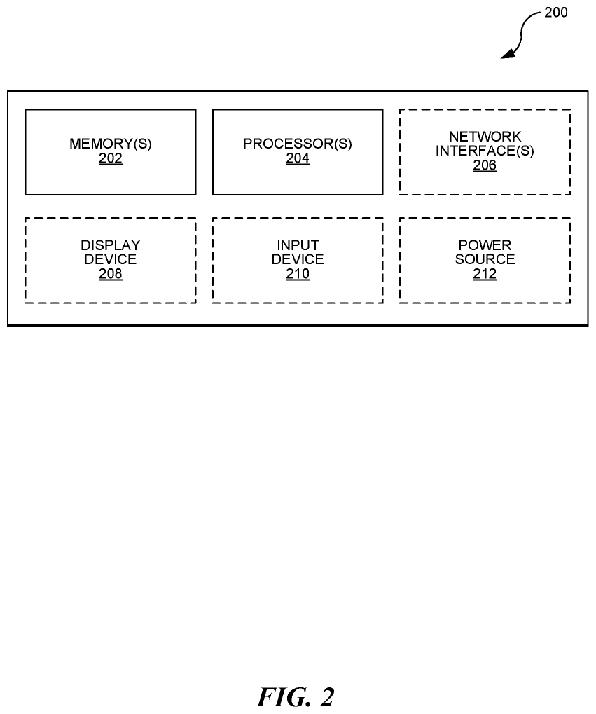

In examples, any of the credit network(s) computing device(s) 102, wallet provider(s) computing device(s) 104, credit exchange(s) computing device(s) 106, at least one borrower computing device 108, at least one lender computing device 110, optional cosigner(s) computing device(s) 112, optional identity provider(s) computing device(s) 114, optional scoring agent(s) computing device(s) 116, optional price feed(s) computing device(s) 118, and distributed ledger(s) 120 can be implemented as any computing device such as any of a mobile computing device, such as a mobile phone, tablet computer, mobile media device, mobile gaming device, laptop computer, vehicle-based computer, etc.; or a non-mobile device such as a dedicated terminal, a public terminal, a kiosk, a server, or a desktop computer. In examples, any of the credit network(s) computing device(s) 102, wallet provider(s) computing device(s) 104, credit exchange(s) computing device(s) 106, at least one borrower computing device 108, at least one lender computing device 110, optional cosigner(s) computing device(s) 112, optional identity provider(s) computing device(s) 114, optional scoring agent(s) computing device(s) 116, optional price feed(s) computing device(s) 118, and distributed ledger(s) 120 can have similar components to the example computing device 200 shown in FIG. 2 and described below. In examples, each computing device 200 includes at least one memory, at least one processor, at least one optional display device, at least one optional input device, at least one optional network interface, and at least one power source.

In examples, the wallet provider(s) computing device(s) 104 can be implemented by companies or other parties that want to offer credit services to users. In examples, the wallet provider(s) computing device(s) 104 are configured to receive a credit request for a loan having credit terms for a borrower from a borrower computing device 108. In examples, each borrower performs a credit request through using their borrower computing device 108 through their wallet provider(s) computing device(s) 104 that has already been integrated into the system 100. In examples, the borrower and/or the wallet provider(s) computing device(s) 104 may generate the terms and/or use information from the credit network(s) computing device(s) 102 to receive and/or generate appropriate terms. The borrower then waits for approval of the credit request.

In examples, the wallet provider(s) computing device(s) 104 are configured to generate a smart contract including information regarding the borrower and the credit terms. In examples, the credit terms may include any of: (1) a first amount for the loan, (2) a first currency type for the loan, (3) a first identification (ID) for the borrower, (4) a first credit score for the borrower, and/or (5) first default terms under which the cosigner takes responsibility for obligations of a lender for credit extended to the borrower. In examples, the cosigner is an institution (such as a bank, collection company, online retail company, lending platform, lending project, wallet provider, etc.) or a person. In examples, the smart contract is signed by a borrower's private key. In example embodiments, a borrower, lender, and/or cosigner each have private keys used to encrypt and sign message and transactions that use asymmetric cryptography.

In examples, the wallet provider(s) computing device(s) 104 are configured to communicate the smart contract to the credit network(s) computing device(s) 102. In examples, optional cosigner(s) computing device(s) 112 receive the smart contract from the credit network(s) computing device(s) 102. In examples, the cosigner can review the information regarding the borrower and the credit terms and decide to cosign for the credit request and communicate an indication from the cosigner(s) computing device(s) 112 to the credit network(s) computing device(s) 102 that the cosigner will cosign for the credit request on behalf of the borrower. In examples, the various cosigners listen to network events for credit creation (such as Ethereum events) or monitor the blockchain in another similar way to discover new credit requests. In examples, the cosigners publish what types of coverage they would be willing to give at what price and for what loan. In examples, this publishing occurs via an Application Programming Interface (API) and is off-chain (not a blockchain procedure).

In examples, the credit network(s) computing device(s) 102 and/or the optional identity provider(s) computing device(s) 114 are configured to verify the identity of the borrower based on identity information from the optional identity provider(s). In examples, the credit network(s) computing device(s) 102 and/or the optional identity provider(s) computing device(s) 114 identifies each borrower and verifies that the borrow is who they claim to be to prevent fraud and/or scams and to provide the borrower information in case of default.

In examples, the credit network(s) computing device(s) 102 and/or optional scoring agent(s) computing device(s) 116 are configured to analyze information regarding the borrower to statistically evaluate the probability of default on the loan by the borrower and/or generate a score for the borrower based on the probability of default on the loan by the borrower. In examples, the cosigner can be presented with and use the verification of the identity of the borrower and/or the analysis and/or score for the borrower in making the determination on whether to decide to cosign for the credit request. In examples, the credit network(s) computing device(s) 102 and/or optional scoring agent(s) computing device(s) 116 are configured to gather transaction information relating to previous transactions for a borrower (such as transaction data stored in the distributed ledger(s) 120) to build a credit ledger for borrowers.

In examples, the credit network(s) computing device(s) 102 and/or the cosigner(s) computing device(s) 112 are configured to group a plurality of smart contracts (generated by wallet provider(s) computing device(s) 104), including the smart contract, into a portfolio of smart contracts where the cosigner agrees to cosign for the whole portfolio of smart contracts, including the smart contract. In examples, the credit network(s) computing device(s) 102 and/or the cosigner(s) computing device(s) 112 are configured to select the plurality of smart contracts for grouping based on the verification of the identity of the borrower and/or the analysis and/or score for the borrower. In examples, credit network(s) computing device(s) 102 and/or the cosigner(s) computing device(s) 112 are configured to select the plurality of smart contracts for grouping into the portfolio of smart contracts in an effort to diversify the portfolio of smart contracts. In examples, credit network(s) computing device(s) 102 and/or the cosigner(s) computing device(s) 112 are configured to select the plurality of smart contracts for grouping into the portfolio of smart contracts based on homogenous risk. In examples, the cosigner(s) will be able to estimate and predict expected loss for a portfolio of similar rates and add this information to the smart contract under different conditions to then be selected by lenders. In examples, the default terms, under which the cosigner takes responsibility for the lender's obligations, will be clearly specified in the smart contract.

In examples, the price feed(s) computing device(s) 118 are used to provide pricing data between a token used within the credit network(s) computing device(s) 102 and traditional currencies (such as US Dollars, Euros, Mexican Pesos, Reales, etc.). In examples, original loan funding from the lender to the borrower and remittance payments from the borrower to the lender are transacted through the system 100 using credit tokens, since it is not possible to send tradition money, and the credit tokens can be converted to and from various currencies by the borrower and/or lender as desired.

In examples, the credit network(s) computing device(s) 102 are configured to communicate indication(s) that cosigner(s) will cosign for the credit request on behalf of the borrower to the credit exchange(s) computing device(s) 106. In examples, the credit network(s) computing device(s) 102 are configured to communicate the smart contract representing the credit request to the credit exchange(s) computing device(s) 106, which places the credit request on an order book of the credit exchange(s) computing device(s) 106. In examples, the smart contract (which has been agreed to be cosigned by the cosigner) listed in the order book may include any of: (1) a first amount for the loan, (2) a first currency type for the loan, (3) a first identification (ID) for the borrower, (4) a first credit score for the borrower, (5) first default terms under which the cosigner takes responsibility for obligations of a lender for credit extended to the borrower, and/or insurance options. In examples, the smart contract is signed by a borrower's private key. In examples, lenders can search through the order book of the credit exchange(s) computing device(s) 106 to find the smart contract representing the credit request.

In examples, the credit exchange(s) computing device(s) 106 receive a trading order for a lender for the smart contract representing the credit request from a lender computing device 110. In examples, lenders have purchased credit tokens specific for lending previously that are required to create a trading order. In examples, the credit exchange(s) computing device(s) 106 is configured to confirm the trading order for the lender matches the credit terms of the smart contract representing the credit request such that the loan is executed between the borrower, the cosigner, and the lender. In examples, when the credit exchange(s) computing device(s) 106 confirm the trading order for the lender matches the credit terms of the smart contract representing the credit request, the lender signs the smart contract with the lender's private key and the smart contract is executed and the credit tokens for the loan are transferred to the borrower's account at the wallet provider(s) computing device(s) 104 from the lender's account. In examples, the wallet provider(s) computing device(s) 104 convert the credit tokens into the local currency for the buyer. In examples, once the lender signs the smart contract with the lender's private key, the cosigner is then requested to sign and signs the smart contract with the cosigner's private key such that the executed contract has been signed by each of the borrower, lender, and cosigner. In examples, the cosigner confirms its participation by signing the contract after it has already been funded. In examples if the cosigner (or other party) does not confirm participation in the smart contract by signing the smart contract, the entire operation is reversed and the credit tokens are returned to the lender.

In examples, the credit network(s) computing device(s) 102 and/or the credit exchange(s) computing device(s) 106 commit the executed smart contract to a distributed ledger 120, such as an Ethereum (or other) blockchain. In examples, the distributed ledger 120 is not necessary and the executed smart contract can be stored in a database or in other ways. In examples, any of the credit network(s) computing device(s) 102, wallet provider(s) computing device(s) 104, credit exchange(s) computing device(s) 106, at least one borrower computing device 108, at least one lender computing device 110, optional cosigner(s) computing device(s) 112, optional identity provider(s) computing device(s) 114, optional scoring agent(s) computing device(s) 116, optional price feed(s) computing device(s) 118, and distributed ledger(s) 120 can be implemented on a single computing system or distributed among multiple computing systems. In examples, the wallet provider(s) computing device(s) 104, credit network(s) computing device(s) 102, and/or credit exchange(s) computing device(s) 106 also include nodes of a distributed ledger, such as a blockchain.

In examples, one the smart contract is signed by the borrower, lender, and cosigner, the borrower is bound with the lender to repay the loan based on a payment obligation such as a commitment to return the funds plus interest in periodic installments. In examples, the wallet provider(s) computing device(s) 104 informs the borrower (via the borrower computing device 108 or otherwise) of the due dates and installment amounts. In examples, the total amount of the payments will depend on the exchange rate set by the price feed(s) computing device(s) 118, which oversee market conditions at a particular moment. In examples, the payment amount paid by the borrower will be traded for credit tokens by the wallet provider(s) computing device(s) 104 and sent to the lender and the lender can then decide whether to keep the credit tokens or to trade them for another cryptocurrency, fiat currency, or other asset.

In examples, in case of a default, the cosigner acts on behalf of the borrower by taking responsibility for the debt amount, according to insurance conditions noted in the smart contract. In examples, the smart contract also determines if the cosigner is obligated to make a unique payment to the lender or if the cosigner will continue to bear the expense of the periodic installments under the original conditions. In examples, the cosigner acts as a reinsurer that distributes and reduces the lender's investment risk and also improves the contract conditions on the borrower side by connecting with the borrower's local laws.

Without the cosigner, a default in a peer-to-peer (P2P) loan may result in a non-balanced loss. In examples without a cosigner, the lender wouldn't know whether the borrower will have enough payment capacity in the future to pay back the debt. In examples, the lender faces uncertainty without a cosigner as the same action in seemingly similar conditions results in different outcomes as some borrows pay back the loan while others do not. In examples, a single investor cannot effectively diversify the credit risk in direct peer-to-peer (P2P) loans without a cosigner. In examples, a cosigner can acts as an intermediary agent with enough credit volume to use statistics to minimize the risk. In order to minimize risk, the lender's risk on a credit investment should be: (1) finite; (2) accidental by nature; (3) measurable; and (4) independent. Finite risk means that the parameters of the event are clearly defined. Accidental by nature risk means that the lender does not have control of the event in order to avoid manipulation and anti-selection. Measurable risk means that the economic value of the loss should be determinable—there should to be enough data available in order to evaluate the risk with a high degree of confidence. Independent risk means that exposure units are spatially and temporally separate from each other such that if one lender has a claim it does not affect another lender's claim.

In examples, a cosigner is used to address the risk minimization problem. In examples with the cosigner, even though a default keeps occurring with the cosigner, the risk has been minimized. In examples with the cosigner, the lenders have traded higher but more uncertain profit for lower but more certain profit because at least some of the risk and surplus are transferred to the cosigner, who collects a pre-defined premium to guarantee the loan. In some cases, the cosigner stands for 100% of the loan. In other cases, the cosigner stands for a smaller percentage of the loan such that the lender may loose a larger amount of his investment in case of a default, but his profit will be higher if there's not default event. In examples, the risk transferred to the cosigner is smaller but the cost (pure premium) is lower on the lender side. In examples, the lender can select a loan based on the cosigner's terms for warranty and fees/cost (pure premium). In examples, cosigners may evaluate their participation on the loss and use that do estimate a pure premium for them to undertake the responsibility as cosigner. The following Formula 1 can be used to aid in these decisions:

$$PP = Frequency * Severity * ( 1 - LER ) , where PP is$$

$$Pure Premium and$$

$$LER = \frac{amount of losses eliminted}{total amount of losses}$$

In practice, the loan amount (Amount Exposed) will be quite different and, in case of a default the borrower is likely to have paid a few installments already, so the debt would be a portion of the initial amount and is referred to as Exposure at Default (EAD). In addition in examples, in case of a default, the cosigner is able to manage the debt in the borrower's country of residence. This represents another key advantage of the cosigner, because without the cosigner acting as a local agent, the lender would have to manage the debt and collect the defaulted funds on its own, which can be particularly difficult if the borrower and lender are located in different countries. By managing the debt, the loss undertaken by the lender and the cosigner, referred to as Loss Given Default (LGD), is substantially reduced. This also allows the cosigner to estimate the pure premium similar to how the traditional banking system does to predict a loss, referred to as Expected Loss (EL). The following Formula 2 can be used to determine the Pure Premium in this situation:

PP=EL, where EL=PD*(EAD*LGD*Amount Exposed)

In examples, the cosigner has a greater capacity than the lender to undertake any estimation deviation. In examples, the cosigner uses its know-how to estimate the score that will be included in the smart contract and to assess an estimated loss beforehand (that could or could not be the same in the future). In examples, this is why the cosigner adds a statist safety margin (risk charge) in order to cover unfavorable and/or unexpected scenarios. In examples, the cosigner will add an amount over the Pure Premium to cover its expenses and a desired profit. The cosigner may use the following Formula 3 to calculate its premium: premium=PP+risk charge+expense of doing business+profit, where PP is pure premium. In examples, Formula 3 explains how the cosigner collects his premium and reveals its components. In examples, the same Formula 3 works to deal with future default events in unexpected/worse scenarios, undertaking the cosigner's expenses while leaving a profit margin to participate in the system 100.

In examples, tokens are used as incentives within the system 100. In examples, tokens are used for transactions within the system 100. In examples, each of wallet provider(s) computing device(s) 104, credit network(s) computing device(s) 102, and credit exchange(s) computing device(s) 106 use tokens for transactions. In examples, borrowers and lenders can exchange tokens for other currencies. In examples, economic value of tokens are based on supply and demand such that the value of the tokens increases as more participant agents (such as cosigners, identity provider(s) computing device(s) 114, and scoring agent(s) computing device(s) 116) require the tokens to use the network.

In examples, tokens are provided to parties that provide services for the system 100. In examples, the identity provider(s) computing device(s) 114 receive tokens (or other fees) in exchange for verifying the borrower's identify. In examples, the scoring agent(s) computing device(s) 116 receive tokens (or other fees) in exchange for providing data and a credit rating/score for the borrower. In examples, cosigners collect a premium in tokens (or other fees) in exchange for cosigning the smart contract together with the borrowers. In examples, tokens are used in exchange for services on the system 100. In examples, when the lender signs a smart contracts listed on credit exchange(s) computing device(s) 106, tokens are paid by the lender to fund the other agents, such as the cosigner, identity provider(s) computing device(s) 114 and/or scoring agent(s) computing device(s) 116. In examples, tokens are used as settlement mechanism for each of the services consumed within the network.

In examples, tokens are used to fund the loans. In examples, when the lender signs a smart contract listed on credit exchange(s) computing device(s) 106, credit tokens are sent from the credit exchange(s) computing device(s) 106 to the borrower's wallet at the wallet provider(s) computing device(s) 104 to fund the credit request for the loan made by the borrower and the wallet provider(s) computing device(s) 104 can exchange the credit tokens for the borrower's preferred currency.

FIG. 2 is a block diagram of an example computing device 200 for use within a smart contract based credit system/network, such as system/network 100 described above. In examples, any of the credit network(s) computing device(s) 102, wallet provider(s) computing device(s) 104, credit exchange(s) computing device(s) 106, at least one borrower computing device 108, at least one lender computing device 110, optional cosigner(s) computing device(s) 112, optional identity provider(s) computing device(s) 114, optional scoring agent(s) computing device(s) 116, optional price feed(s) computing device(s) 118, and distributed ledger(s) 120 can be implemented using the example computing device 200. In examples, computing device 200 includes at least one memory 202, at least one processor 204, optional network interface(s) 206, optional display device(s) 208, optional input device(s) 210, and at least one optional power source 212.

In exemplary embodiments, the at least one memory 202 can be any device, mechanism, or populated data structure used for storing information. In exemplary embodiments, the at least one memory 202 can be or include any type of volatile memory, nonvolatile memory, and/or dynamic memory. For example, the at least one memory 202 can be random access memory, memory storage devices, optical memory devices, magnetic media, floppy disks, magnetic tapes, hard drives, erasable programmable read-only memories (EPROMs), electrically erasable programmable read-only memories (EEPROMs), optical media (such as compact discs, DVDs, Blu-ray Discs) and/or the like. In accordance with some embodiments, the at least one memory 202 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as the at least one memory 202. The at least one memory 202 may be used to store instructions for running one or more applications or modules on the at least one processor 204. For example, the at least one memory 202 could be used in one or more embodiments to house all or some of the instructions needed to execute the functionality of elements of the components of the system 100 described above.

In exemplary embodiments, the at least one processor 204 can be any known processor, such as a general purpose processor (GPP) or special purpose (such as a field-programmable gate array (FPGA), application-specific integrated circuit (ASIC) or other integrated circuit or circuitry), or any programmable logic device. In exemplary embodiments, functionality of elements of the components of the system 100 described above are implemented by the at least one processor 204 and the at least one memory 202.

In exemplary embodiments, the optional network interface(s) 206 includes or is coupled to at least one optional antenna for communication with a network. In exemplary embodiments, the optional network interface(s) 206 includes at least one of an Ethernet interface, a cellular radio access technology (RAT) radio, a WiFi radio, a Bluetooth radio, or a near field communication (NFC) radio. In exemplary embodiments, the optional network interface(s) 206 includes a cellular radio access technology radio configured to establish a cellular data connection (mobile internet) of sufficient speeds with a remote server using a local area network (LAN) or a wide area network (WAN). In exemplary embodiments, the cellular radio access technology includes at least one of Personal Communication Services (PCS), Specialized Mobile Radio (SMR) services, Enhanced Special Mobile Radio (ESMR) services, Advanced Wireless Services (AWS), Code Division Multiple Access (CDMA), Global System for Mobile Communications (GSM) services, Wideband Code Division Multiple Access (W-CDMA), Universal Mobile Telecommunications System (UMTS), Worldwide Interoperability for Microwave Access (WiMAX), 3rd Generation Partnership Projects (3GPP) Long Term Evolution (LTE), High Speed Packet Access (HSPA), third generation (3G) fourth generation (4G), fifth generation (5G), etc. or other appropriate communication services or a combination thereof. In exemplary embodiments, the optional network interface(s) 206 includes a WiFi (IEEE 802.11) radio configured to communicate with a wireless local area network that communicates with the remote server, rather than a wide area network. In exemplary embodiments, the optional network interface(s) 206 includes a near field radio communication device that is limited to close proximity communication, such as a passive near field communication (NFC) tag, an active near field communication (NFC) tag, a passive radio frequency identification (RFID) tag, an active radio frequency identification (RFID) tag, a proximity card, or other personal area network device. In exemplary embodiments, the same optional network interface(s) 206 is also used for communication with an external gateway device to a network (such as an NFC payment terminal).

In exemplary embodiments, the optional at least one display device 208 includes at least one of a light emitting diode (LED), a liquid crystal display (LCD), a light emitting diode (LED) display, an organic light emitting diode (OLED) display, an e-ink display, a field emission display (FED), a surface-conduction electron-emitter display (SED), or a plasma display. In exemplary embodiments, the optional input device(s) 210 include at least one of a touchscreen (including capacitive and resistive touchscreens), a touchpad, a capacitive button, a mechanical button, a switch, a dial, a keyboard, a mouse, a camera, a biometric sensor/scanner, etc. In exemplary embodiments, the optional at least one display device 208 and the optional input device(s) 210 are combined into a human machine interface (HMI) for user interaction with the computing device 200.

In exemplary embodiments, at least one optional power source 212 is used to provide power to the various components of the computing device 200.

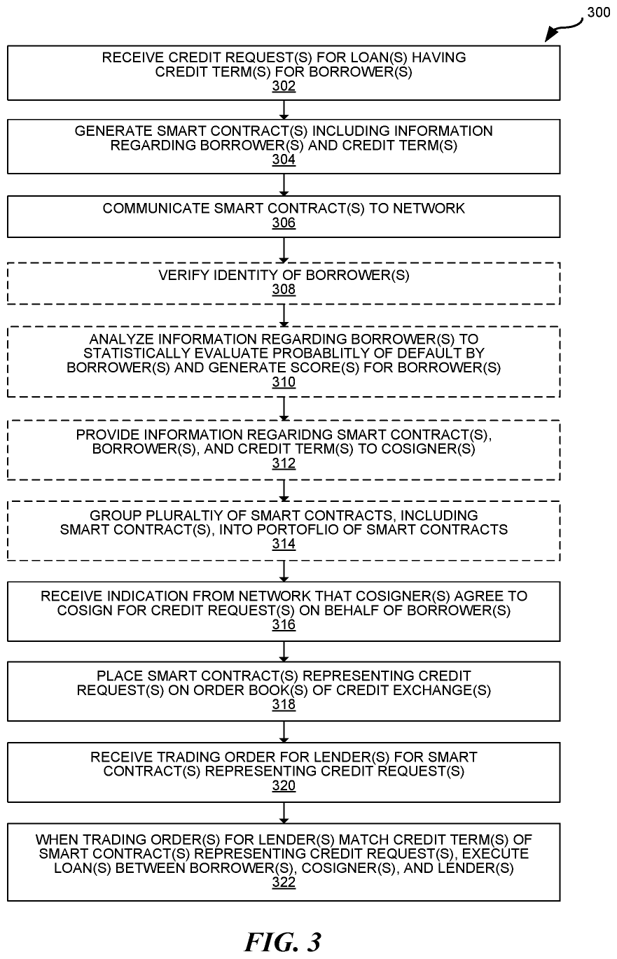

FIG. 3 is a flow diagram of an example method 300 for implementing a smart contract based credit system/network. Exemplary method 300 begins at block 302 with receiving credit request(s) for loan(s) having credit term(s) for borrower(s). Exemplary method 300 proceeds to block 304 with generating smart contract(s) including information regarding borrower(s) and credit term(s). Exemplary method 300 proceeds to block 306 with communicating smart contract(s) to network.

Exemplary method 300 proceeds to optional block 308 with verifying the identity of the borrower(s). Exemplary method 300 proceeds to optional block 310 with analyzing information regarding the borrower(s) to statistically evaluate the probability of a default by the borrower(s) and generate score(s) for borrower(s). Exemplary method 300 proceeds to optional block 312 with providing information regarding the smart contract(s), borrower(s), and credit term(s) to cosigner(s). Exemplary method 300 proceeds to optional block 314 with grouping a plurality of smart contracts, including the smart contract(s), into a portfolio of smart contracts.

Exemplary method 300 proceeds to block 316 with receiving indication from network nodes(s) that cosigner(s) agree to cosign for credit request(s) on behalf of borrower(s). Exemplary method 300 proceeds to block 318 with placing smart contract(s) representing credit request(s) on order book(s) of credit exchange(s). Exemplary method 300 proceeds to block 320 with receiving trading order for lender(s) for smart contract(s) representing credit request(s). Exemplary method proceeds to block 322 with executing loan(s) between borrower(s), cosigner(s), and lender(s) when trading order(s) for lender(s) match credit term(s) of smart contract(s) representing credit request(s), executing loan(s) between borrower(s), cosigner(s), and lender(s). In examples, the loan is executed when the lender signs the corresponding smart contract (previously signed by the borrower's private key) with the Lender's private key such that the funds are transferred from the lender's account to the borrower's account and the cosigner also signs the smart contract with the cosigner's private key. In examples, the executed smart contract is committed to a blockchain (such as an Ethereum blockchain) or other distributed ledger.

The techniques introduced here can be embodied as special-purpose hardware (such as circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, for example, floppy diskettes, optical disks, compact disc read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

Computer System Overview

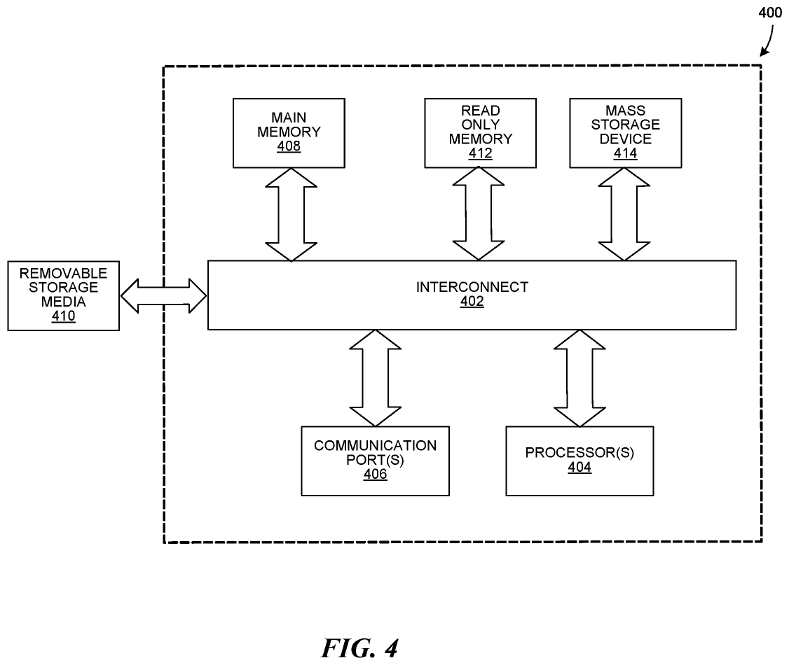

Embodiments of the present disclosure include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 4 is an example of a computer system 400 with which embodiments of the present disclosure may be utilized. According to the present example, the computer system 400 includes an interconnect 402, at least one processor 404, at least one communication port 406, at least one main memory 408, at least one removable storage media 410, at least one read only memory 412, and at least one mass storage device 414.

The at least one processor 404 can be any known processor. The at least one communication port 406 can be or include, for example, any of an RS-232 port for use with a modem-based dialup connection, a 10/100 Ethernet port, or a Gigabit port using copper or fiber. The nature of the at least one communication port 406 may be chosen depending on a network such a Local Area Network (LAN), Wide Area Network (WAN), or any network to which the computer system 400 connects. The at least one main memory 408 can be Random Access Memory (RAM), or any other dynamic storage device(s) commonly known in the art. The at least one read only memory 412 can be any static storage device(s) such as Programmable Read Only Memory (PROM) chips for storing static information such as instructions for the at least one processor 80.

The at least one mass storage device 414 can be used to store information and instructions. For example, hard disks (such as magnetic disk drives or solid state drive using serial/parallel ATA or SCSI interfaces), an optical disc, an array of disks such as a Redundant Array of Independent Disks (RAID), or any other mass storage devices may be used. Interconnect 402 can be or include one or more buses, bridges, controllers, adapters, and/or point-to-point connections. Interconnect 402 communicatively couples the at least one processor 404 with the other memory, storage, and communication blocks. Interconnect 402 can be a PCI/PCI-X or SCSI based system bus depending on the storage devices used. The at least one removable storage media 410 can be any kind of external hard-drives, floppy drives, Compact Disc-Read Only Memory (CD-ROM), Compact Disc-Re-Writable (CD-RW), Digital Video Disc-Read Only Memory (DVD-ROM), Blu-Ray Disc Read Only Memory (BD-ROM), Blu-Ray Disc Recordable (BD-R), Blu-Ray Disc Recordable Erasable (BD-RE).

The components described above are meant to exemplify some types of possibilities. In no way should the aforementioned examples limit the disclosure, as they are only exemplary embodiments.

### Terminology

Brief definitions of terms, abbreviations, and phrases used throughout this application are given below.

The terms “connected”, “coupled”, and “communicatively coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in examples”, “in example embodiments”, “in some embodiments,” “according to some embodiments,” “in the embodiments shown,” “in other embodiments,” “embodiments,” and the like generally mean the particular feature, structure, or characteristic following the phrase is included in at least one embodiment of the present disclosure, and may be included in more than one embodiment of the present disclosure. In addition, such phrases do not necessarily refer to the same embodiments or different embodiments.

If the specification states a component or feature “may,” “can,” “could,” or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein, “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Also, for the sake of illustration, various embodiments of the present disclosure have herein been described in the context of computer programs, physical components, and logical interactions within modern computer networks. Importantly, while these embodiments describe various embodiments of the present disclosure in relation to modern computer networks and programs, the method and apparatus described herein are equally applicable to other systems, devices, and networks as one skilled in the art will appreciate. As such, the illustrated applications of the embodiments of the present disclosure are not meant to be limiting, but instead are examples. Other systems, devices, and networks to which embodiments of the present disclosure are applicable include, for example, other types of communication and computer devices and systems. More specifically, embodiments are applicable to communication systems, services, and devices such as cell phone networks and compatible devices. In addition, embodiments are applicable to all levels of computing from the personal computer to large network mainframes and servers.

While detailed descriptions of one or more embodiments of the disclosure have been given above, various alternatives, modifications, and equivalents will be apparent to those skilled in the art without varying from the spirit of the disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof. Therefore, the above description should not be taken as limiting.

### Example Embodiments

Example 1 includes a system comprising: at least one wallet provider computing device; at least one credit network computing device communicatively coupled to the at least one wallet provider computing device; at least one credit exchange computing device communicatively coupled to the at least one credit network computing device; wherein the at least one wallet provider computing device is configured to receive a credit request for a loan having credit terms from a borrower from a borrower computing device communicatively coupled to the at least one wallet provider computing device; wherein the at least one wallet provider computing device is configured to generate a smart contract including information regarding the borrower and the credit terms; wherein the at least one wallet provider computing device is configured to communicate the smart contract to the at least one credit network computing device; wherein the at least one credit network computing device is configured to receive an indication that a cosigner agrees to cosign for the credit request on behalf of the borrower; wherein the at least one credit network computing device is configured to communicate the smart contract representing the credit requests to the at least one credit exchange computing device; wherein the at least one credit exchange computing device is configured to place the smart contract representing the credit request on an order book of the at least one credit exchange computing device; wherein the at least one credit exchange computing device is configured to receive a trading order for a lender for the smart contract representing the credit request from a lender computing device; wherein the at least one credit exchange computing device is configured to determine whether the trading order for the lender matches the credit terms of the smart contract representing the credit request; and wherein the at least one credit exchange computing device is configured to execute the loan between the borrower, the cosigner, and the lender when the trading order for the lender matches the credit terms of the smart contract representing the credit request.

Example 2 includes the system of Example 1, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

Example 3 includes the system of any of Examples 1-2, wherein the at least one credit network computing device is configured to provide information regarding the smart contract, borrower, and credit terms to at least one cosigner computing device communicatively coupled to the at least one wallet provider computing device.

Example 4 includes the system of Example 3, wherein the at least one credit network computing device is configured to receive the indication that the cosigner agrees to cosign for the credit request on behalf of the borrower from the at least one cosigner computing device.

Example 5 includes the system of any of Examples 3-4, further comprising: wherein at least one of the at least one credit network computing device and the at least one cosigner computing device is configured to group a plurality of smart contracts, including the smart contract, into a portfolio of smart contracts; and wherein the cosigner agrees to cosign for the portfolio of smart contracts.

Example 6 includes the system of Example 5, further comprising: wherein the at least one of the at least one credit network computing device and the at least one cosigner computing device is configured to select the plurality of smart contracts for grouping into the portfolio of smart contracts to diversify the portfolio of smart contracts.

Example 7 includes the system of any of Examples 5-6, further comprising: wherein the at least one of the at least one credit network computing device and the at least one cosigner computing device is configured to select the plurality of smart contracts for grouping into the portfolio of smart contracts based on homogenous risk.

Example 8 includes the system of any of Examples 1-7, further comprising: wherein at least one of the at least one credit network computing device and at least one identity provider computing device communicatively coupled to the at least one credit network computing device is configured to verify the identity of the borrower.

Example 9 includes the system of any of Examples 1-8, further comprising wherein at least one of the at least one credit network computing device and at least one scoring agent computing device is configured to: analyze information regarding the borrower to statistically evaluate probability of default on the loan by the borrower; and generate a score for the borrower based on probability of default on the loan by the borrower.

Example 10 includes the system of any of Examples 1-9, wherein the at least one credit exchange computing device is configured to execute the loan between the borrower, the cosigner, and the lender at least in part by: receiving a signature of the smart contract with a first private key of the lender, where the smart contract had been previously signed with a second private key of the borrower; and transferring funds for the loan from a first account of the lender to a second account of the borrower; receiving a signature of the smart contract with a third private key of cosigner to execute the smart contract; and committing the executed smart contract to a distributed ledger.

Example 11 includes the system of Example 10, wherein the distributed ledger is an Ethereum blockchain.

Example 12 includes the system of any of Examples 1-11, wherein any of the at least one wallet provider computing device, the at least one credit network computing device, the at least one credit exchange computing device, the at least one borrower computing device, and the at least one lender computing device are selected from at least one of servers, personal computers, laptop computers, tablet computers, or smart phones.

Example 13 includes the system of any of Examples 1-12, wherein the at least one wallet provider computing device, the at least one credit network computing device, the at least one credit exchange computing device, the at least one borrower computing device, and the at least one lender computing device are communicatively coupled using at least one of at least one wired network or at least one wireless network.

Example 14 includes the system of any of Examples 1-13, wherein the at least one wallet provider computing device, the at least one credit network computing device, the at least one credit exchange computing device, the at least one borrower computing device, and the at least one lender computing device are communicatively coupled over at least one of at least one local area network, at least one wide area network, or the Internet.

Example 15 includes a method comprising: receiving a credit request for a loan having credit terms for a borrower from at least one borrower computing device at at least one wallet provider computing device; generating a smart contract at the at least one wallet provider computing device, wherein the smart contract includes information regarding the borrower and the credit terms; communicating the smart contract to at least one credit network computing device; receiving an indication nodes that a cosigner agrees to cosign for the credit request on behalf of the borrower at the at least one credit network computing device; communicating the smart contract representing the credit request to at least one credit exchange computing device; placing the smart contract representing the credit request on an order book of the at least one credit exchange computing device; receiving a trading order for a lender for the smart contract representing the credit request from a lender computing device at the at least one credit exchange computing device; and determining whether the trading order for the lender matches the credit terms of the smart contract representing the credit request; when the trading order for the lender matches the credit terms of the smart contract representing the credit request, executing the loan between the borrower, the cosigner, and the lender.

Example 16 includes the method of Example 15, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

Example 17 includes the method of any of Examples 15-16, further comprising: providing information regarding the smart contract, borrower, and credit terms from the at least one credit network computing device to at least one cosigner computing device communicatively coupled to the at least one wallet provider computing device.

Example 18 includes the method of Example 17, further comprising: receiving the indication that the cosigner agrees to cosign for the credit request on behalf of the borrower from the at least one cosigner computing device at the at least one credit network computing device.

Example 19 includes the method of any of Examples 17-18, further comprising: grouping a plurality of smart contracts, including the smart contract, into a portfolio of smart contracts; and wherein the cosigner agrees to cosign for the portfolio of smart contracts.

Example 20 includes the method of Example 19, further comprising: selecting the plurality of smart contracts for grouping into the portfolio of smart contracts to diversify the portfolio of smart contracts.

Example 21 includes the method of any of Examples 19-20, further comprising: selecting the plurality of smart contracts for grouping into the portfolio of smart contracts based on homogenous risk.

Example 22 includes the method of any of Examples 15-21, further comprising: verifying the identity of the borrower.

Example 23 includes the method of any of Examples 15-22, further comprising: analyzing information regarding the borrower to statistically evaluate probability of default on the loan by the borrower; and generating a score for the borrower based on probability of default on the loan by the borrower.

Example 24 includes the method of any of Examples 1-23, executing the loan between the borrower, the cosigner, and the lender includes: receiving a signature of the smart contract with a first private key of the lender, where the smart contract had been previously signed with a second private key of the borrower; and transferring funds for the loan from a first account of the lender to a second account of the borrower; receiving a signature of the smart contract with a third private key of cosigner to execute the smart contract; and committing the executed smart contract to a distributed ledger.

Example 25 includes the method of Example 24, wherein the distributed ledger is an Ethereum blockchain.

Example 26 includes a system comprising: a plurality of network nodes coupled in a network including: at least a first network node communicatively coupled to a first computing device; and at least a second network node communicatively coupled to a second computing device; wherein the at least the first network node is configured to receive a credit request for a loan having credit terms for a borrower from the first computing device; wherein the at least the first network node is configured to generate a smart contract including information regarding the borrower and the credit terms; wherein the at least the first network node is configured to communicate the smart contract to the plurality of network nodes; wherein at least one of the plurality of network nodes is configured to communicate an indication that a cosigner will cosign for the credit request on behalf of the borrower; wherein at least one of the plurality of network nodes is configured to place the smart contract representing the credit request on an order book of a credit exchange; wherein the at least the second network node is configured to receive a trading order for a lender for the smart contract representing the credit request from a second computing device; and wherein at least one of the plurality of network nodes is configured to confirm the trading order for the lender matches the credit terms of the smart contract representing the credit request such that the loan is executed between the borrower, the cosigner, and the lender.

Example 27 includes the system of Example 26, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

Example 28 includes the system of any of Examples 26-27, further comprising: wherein at least one network node of the plurality of network nodes is configured to group a plurality of smart contracts, including the smart contract, into a portfolio of smart contracts; and wherein the cosigner agrees to cosign for the portfolio of smart contracts.

Example 29 includes the system of Example 28, further comprising: wherein at least one network node of the plurality of network nodes is configured to select the plurality of smart contracts for grouping into the portfolio of smart contracts to diversify the portfolio of smart contracts.

Example 30 includes the system of any of Examples 28-29, further comprising: wherein at least one network node of the plurality of network nodes is configured to select the plurality of smart contracts for grouping into the portfolio of smart contracts based on homogenous risk.

Example 31 includes the system of any of Examples 26-30, further comprising: wherein at least one network node of the plurality of network nodes is configured to verify the identity of the borrower.

Example 32 includes the system of any of Examples 26-31, further comprising wherein at least one of the network node of the plurality of network nodes is configured to: analyze information regarding the borrower to statistically evaluate probability of default on the loan by the borrower; and generate a score for the borrower based on probability of default on the loan by the borrower.

Example 33 includes the system of any of Examples 26-32, wherein the loan is executed between the borrower, the cosigner, and the lender at least in part by: signing the smart contract with a first private key of the lender, where the smart contract had been previously signed with a second private key of the borrower; and transferring funds for the loan from a first account of the lender to a second account of the borrower; signing the smart contract with a third private key of cosigner to execute the smart contract; and committing the executed smart contract to a distributed ledger.

Example 34 includes the system of Example 33, wherein the distributed ledger is an Ethereum blockchain.

Example 35 includes the system of any of Examples 26-34, wherein any of the plurality of network nodes or the plurality of computing devices are selected from at least one of servers, personal computers, laptop computers, tablet computers, or smart phones.

Example 36 includes the system of any of Examples 26-35, wherein the plurality of network nodes are geographically distributed across the world.

Example 37 includes the system of any of Examples 26-36, wherein the plurality of network nodes are communicatively coupled using at least one of at least one wired network or at least one wireless network.

Example 38 includes the system of any of Examples 26-37, wherein the plurality of network nodes are communicatively coupled over at least one of at least one local area network, at least one wide area network, or the Internet.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

1. A system comprising:
at least one wallet provider computing device;
at least one credit network computing device communicatively coupled to the at least one wallet provider computing device;
at least one credit exchange computing device communicatively coupled to the at least one credit network computing device;
wherein the at least one wallet provider computing device is configured to receive a credit request for a loan having credit terms from a borrower from a borrower computing device communicatively coupled to the at least one wallet provider computing device;
wherein the at least one wallet provider computing device is configured to generate a smart contract including information regarding the borrower and the credit terms;
wherein the at least one wallet provider computing device is configured to communicate the smart contract to the at least one credit network computing device;
wherein the at least one credit network computing device is configured to receive an indication that a cosigner agrees to cosign for the credit request on behalf of the borrower;
wherein the at least one credit network computing device is configured to communicate the smart contract representing the credit requests to the at least one credit exchange computing device;
wherein the at least one credit exchange computing device is configured to place the smart contract representing the credit request on an order book of the at least one credit exchange computing device;
wherein the at least one credit exchange computing device is configured to receive a trading order for a lender for the smart contract representing the credit request from a lender computing device;
wherein the at least one credit exchange computing device is configured to determine whether the trading order for the lender matches the credit terms of the smart contract representing the credit request; and
wherein the at least one credit exchange computing device is configured to execute the loan between the borrower, the cosigner, and the lender when the trading order for the lender matches the credit terms of the smart contract representing the credit request.

2. The system of claim 1, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

3. The system of claim 1, wherein the at least one credit network computing device is configured to provide information regarding the smart contract, borrower, and credit terms to at least one cosigner computing device communicatively coupled to the at least one wallet provider computing device.

4. (canceled)

5. The system of claim 3, further comprising:
wherein at least one of the at least one credit network computing device and the at least one cosigner computing device is configured to group a plurality of smart contracts, including the smart contract, into a portfolio of smart contracts; and
wherein the cosigner agrees to cosign for the portfolio of smart contracts.

6. The system of claim 5, further comprising:
wherein the at least one of the at least one credit network computing device and the at least one cosigner computing device is configured to select the plurality of smart contracts for grouping into the portfolio of smart contracts to diversify the portfolio of smart contracts.

7. The system of claim 5, further comprising:
wherein the at least one of the at least one credit network computing device and the at least one cosigner computing device is configured to select the plurality of smart contracts for grouping into the portfolio of smart contracts based on homogenous risk.

8. (canceled)

9. The system of claim 1, further comprising wherein at least one of the at least one credit network computing device and at least one scoring agent computing device is configured to:
analyze information regarding the borrower to statistically evaluate probability of default on the loan by the borrower; and
generate a score for the borrower based on probability of default on the loan by the borrower.

10. The system of claim 1, wherein the at least one credit exchange computing device is configured to execute the loan between the borrower, the cosigner, and the lender at least in part by:
receiving a signature of the smart contract with a first private key of the lender, where the smart contract had been previously signed with a second private key of the borrower; and
transferring funds for the loan from a first account of the lender to a second account of the borrower;
receiving a signature of the smart contract with a third private key of cosigner to execute the smart contract; and
committing the executed smart contract to a distributed ledger.

11-14. (canceled)

15. A method comprising:
receiving a credit request for a loan having credit terms for a borrower from at least one borrower computing device at at least one wallet provider computing device;
generating a smart contract at the at least one wallet provider computing device, wherein the smart contract includes information regarding the borrower and the credit terms;
communicating the smart contract to at least one credit network computing device;
receiving an indication nodes that a cosigner agrees to cosign for the credit request on behalf of the borrower at the at least one credit network computing device;
communicating the smart contract representing the credit request to at least one credit exchange computing device;
placing the smart contract representing the credit request on an order book of the at least one credit exchange computing device;
receiving a trading order for a lender for the smart contract representing the credit request from a lender computing device at the at least one credit exchange computing device; and
determining whether the trading order for the lender matches the credit terms of the smart contract representing the credit request;
when the trading order for the lender matches the credit terms of the smart contract representing the credit request, executing the loan between the borrower, the cosigner, and the lender.

16. The method of claim 15, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

17. The method of claim 15, further comprising:
providing information regarding the smart contract, borrower, and credit terms from the at least one credit network computing device to at least one cosigner computing device communicatively coupled to the at least one wallet provider computing device.

18. (canceled)

19. The method of claim 17, further comprising:
grouping a plurality of smart contracts, including the smart contract, into a portfolio of smart contracts; and
wherein the cosigner agrees to cosign for the portfolio of smart contracts.

20-23. (canceled)

24. The method of claim 1, executing the loan between the borrower, the cosigner, and the lender includes:
receiving a signature of the smart contract with a first private key of the lender, where the smart contract had been previously signed with a second private key of the borrower; and
transferring funds for the loan from a first account of the lender to a second account of the borrower;
receiving a signature of the smart contract with a third private key of cosigner to execute the smart contract; and
committing the executed smart contract to a distributed ledger.

25. (canceled)

26. A system comprising:
a plurality of network nodes coupled in a network including:
at least a first network node communicatively coupled to a first computing device; and
at least a second network node communicatively coupled to a second computing device;
wherein the at least the first network node is configured to receive a credit request for a loan having credit terms for a borrower from the first computing device;
wherein the at least the first network node is configured to generate a smart contract including information regarding the borrower and the credit terms;
wherein the at least the first network node is configured to communicate the smart contract to the plurality of network nodes;
wherein at least one of the plurality of network nodes is configured to communicate an indication that a cosigner will cosign for the credit request on behalf of the borrower;
wherein at least one of the plurality of network nodes is configured to place the smart contract representing the credit request on an order book of a credit exchange;
wherein the at least the second network node is configured to receive a trading order for a lender for the smart contract representing the credit request from a second computing device; and
wherein at least one of the plurality of network nodes is configured to confirm the trading order for the lender matches the credit terms of the smart contract representing the credit request such that the loan is executed between the borrower, the cosigner, and the lender.

27. The system of claim 26, wherein the credit terms include at least one of: (1) a first amount for the loan, (2) a first currency type for the loan, (3) a first identification (ID) for the borrower, (4) a first credit score for the borrower, or (5) first default terms under which the cosigner takes responsibility for obligations of a lender for credit extended to the borrower.

28. The system of claim 26, further comprising:
wherein at least one network node of the plurality of network nodes is configured to group a plurality of smart contracts, including the smart contract, into a portfolio of smart contracts; and
wherein the cosigner agrees to cosign for the portfolio of smart contracts.

29. The system of claim 28, further comprising:
wherein at least one network node of the plurality of network nodes is configured to select the plurality of smart contracts for grouping into the portfolio of smart contracts to diversify the portfolio of smart contracts.

30. The system of claim 28, further comprising:
wherein at least one network node of the plurality of network nodes is configured to select the plurality of smart contracts for grouping into the portfolio of smart contracts based on homogenous risk.

31. (canceled)

32. The system of claim 26, further comprising wherein at least one of the network node of the plurality of network nodes is configured to:
analyze information regarding the borrower to statistically evaluate probability of default on the loan by the borrower; and
generate a score for the borrower based on probability of default on the loan by the borrower.

33. The system of claim 26, wherein the loan is executed between the borrower, the cosigner, and the lender at least in part by:
signing the smart contract with a first private key of the lender, where the smart contract had been previously signed with a second private key of the borrower; and
transferring funds for the loan from a first account of the lender to a second account of the borrower;
signing the smart contract with a third private key of cosigner to execute the smart contract; and
committing the executed smart contract to a distributed ledger.

34-38. (canceled)
